(19) United States
(12) Patent Application Publication
(10) Pub. No.: US 2018/0029829 A1
(43) Pub. Date: Feb. 1, 2018

(54) MECHANICALLY INTEGRATED PROPULSION GUIDING UNIT

(71) Applicant: Otis Elevator Company, Farmington, CT (US)

(72) Inventors: Zbigniew Piech, Cheshire, CT (US); Adam Marian Myszkowski, Ostrow Wlkp (PL); Cezary Jedryczka, Lniano (PL); Wojciech Szelag, Poznan (PL); Arthur Blanc, Providence, RI (US); Beata I. Wawrzyniak, South Windsor, CT (US); Richard N. Fargo, Plainville, CT (US)

(21) Appl. No.: 15/547,432

(22) PCT Filed: Jan. 29, 2016
(86) PCT No.: PCT/US2016/015564

§ 371 Date: Jul. 28, 2017

Related U.S. Application Data
(60) Provisional application No. 62/109,090, filed on Jan. 29, 2015.

(51) Int. Cl. B66B 7/04; B66B 9/00; B66B 7/02

(52) U.S. Cl. CPC B66B 7/04; B66B 7/02; B66B 9/00; B66B 7/048; B66B 9/003; B66B 11/0407

(57) ABSTRACT

A guide assembly (60) for guiding movement of an elevator car (30) is provided including a first (66) and second (68) guide support coupled to the elevator car (30). The first guide support (66) and the second guide support (68) are separated from one another by a gap (G) wider than an adjacent primary portion (42) of a propulsion system (40) of the elevator car (30). A pair of first guides (70) is mounted to the first (66) and second (68) guide support, respectively. The first guides (70) are substantially parallel and are configured to guide movement of the elevator car (30) in a first direction to maintain a clearance between the primary (42) and secondary (44) portions of the propulsion system (40) of the elevator car (30). A second guide (72) is mounted to one of the first (66) and second (68) guide support. The second guide (72) is oriented substantially perpendicular to the first guides (70). The second guide (72) is configured to guide movement of the elevator car (30) in a second direction.

### BACKGROUND OF THE INVENTION

The subject matter disclosed herein relates generally to the field of elevators, and more particularly to a guide assembly of a multicar, ropeless, self-propelled elevator system.

Ropeless elevator systems, also referred to as self-propelled elevator systems, are useful in certain applications (e.g., high rise buildings) where the mass of the ropes for a roped system is prohibitive and there is a desire for multiple elevator cars to travel in a single hoistway or lane. There exist ropeless elevator systems in which a first lane is designated for upward traveling elevator cars and a second lane is designated for downward traveling elevator cars. A transfer station at each end of the lane is used to move cars horizontally between the first lane and second lane.

### BRIEF DESCRIPTION OF THE INVENTION

According to one embodiment, a guide assembly for guiding movement of an elevator car is provided including a first guide support and a second guide support coupled to a portion of the elevator car. The first guide support and the second guide support are separated from one another by a gap wider than an adjacent primary portion of a propulsion system of the elevator car. A pair of first guides is mounted to the first guide support and the second guide support, respectively. The first guides are substantially parallel and are configured to guide movement of the elevator car in a first direction to maintain a clearance between the primary portion and a secondary portion of the propulsion system of the elevator car. A second guide is mounted to one of the first guide support and the second guide support. The second guide is oriented substantially perpendicular to the first guides. The second guide is configured to guide movement of the elevator car in a second direction.

In addition to one or more of the features described above, or as an alternative, further embodiments may include the first guide support and the second guide support are symmetrical about a plane extending parallel to the first and second guide support through a center of the gap.

In addition to one or more of the features described above, or as an alternative, further embodiments the first guide support and the second guide support are connected directly to a portion of the elevator car.

In addition to one or more of the features described above, or as an alternative, further embodiments the first guide support and the second guide support are integrally formed with a portion of the elevator car.

In addition to one or more of the features described above, or as an alternative, further embodiments the first guide support and the second guide support are indirectly coupled to the elevator car via a support member such that the elevator car is isolated from noise and vibration.

In addition to one or more of the features described above, or as an alternative, further embodiments the first guide support is a first structural member of the secondary portion of the propulsion system and the second guide support is a second structural member of the secondary portion of the propulsion system.

In addition to one or more of the features described above, or as an alternative, further embodiments the first guide support is connected to a first structural member of the secondary portion of the propulsion system and the second guide support is connected to the second structural member of the secondary portion of the propulsion system.

In addition to one or more of the features described above, or as an alternative, further embodiments the first guide support and the second guide support extend substantially parallel to the first structural member and the second structural member.

In addition to one or more of the features described above, or as an alternative, further embodiments the guide assembly includes at least one actuator such that one or more of the first guides and the at least one second guide is active.

According to another embodiment of the invention, an elevator system is provided including an elevator car. A vertical structural guide member is arranged adjacent a primary portion of a propulsion system of the elevator car. A secondary portion of the propulsion system is coupled to the elevator car. The secondary portion is arranged parallel to the primary portion of the propulsion system. At least one guide assembly is configured to limit horizontal movement of the elevator car. The guide assembly includes a first guide support and a second guide support coupled to a portion of the elevator car. The first guide support and the second guide support are separated from one another by a gap wider than the primary portion of a propulsion system of the elevator car. A pair of first guides is mounted to the first guide support and the second guide support, respectively. The first guides are configured to contact one or more first wall of at least one structural guide member to limit movement of the elevator car in a first direction. The first guides maintain a clearance between the primary portion and the secondary portion of the propulsion system. At least one second guide is mounted to one of the first guide support and the second guide support. The second guide is oriented substantially perpendicular to the first guides. The second guide is configured to contact a second wall of the at least one structural guide member to guide movement of the elevator car in a second direction.

In addition to one or more of the features described above, or as an alternative, further embodiments the first guide support and the second guide support are directly connected to a portion of the elevator car.

In addition to one or more of the features described above, or as an alternative, further embodiments the first guide support and the second guide support are integrally formed with a portion of the elevator car.

In addition to one or more of the features described above, or as an alternative, further embodiments the first guide support and the second guide support are indirectly coupled to the elevator car via a support member configured to isolate the elevator car from noise and vibration of the at least one guide assembly.

In addition to one or more of the features described above, or as an alternative, further embodiments the elevator system also includes at least one of a safety device and a brake mounted to the elevator car. At least one of the safety device and the brake is configured to engage the support member to slow or stop movement of the elevator car.

In addition to one or more of the features described above, or as an alternative, further embodiments the first guide support is a first structural member of the secondary portion of the propulsion system and the second guide support is a second structural member of the secondary portion of the propulsion system.

In addition to one or more of the features described above, or as an alternative, further embodiments the first guide support is connected to a first structural member of the secondary portion of the propulsion system and the second guide support is connected to a second structural member of the secondary portion of the propulsion system.

In addition to one or more of the features described above, or as an alternative, further embodiments the first guide support and the second guide support extend substantially parallel to the first structural member and the second structural member.

In addition to one or more of the features described above, or as an alternative, further embodiments the elevator system includes at least one actuator such that one or more of the first guides and the at least one second guide is active.

In addition to one or more of the features described above, or as an alternative, further embodiments the at least one structural guide member includes a plurality of first walls extending from opposing ends of the second wall, the plurality of first walls and second walls being integrally formed.

In addition to one or more of the features described above, or as an alternative, further embodiments the at least one structural guide member is a C-channel.

In addition to one or more of the features described above, or as an alternative, further embodiments the at least one structural guide member includes a first structural guide member and a second structural guide member arranged symmetrically on opposing sides of the primary portion of the propulsion system.

In addition to one or more of the features described above, or as an alternative, further embodiments the first structural guide member and the second structural guide member are angles.

Technical features of the invention include providing a guide assembly system that limits movement of the primary and secondary portions of the propulsion system.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a front view of an example of a multicar elevator system;

FIG. 2 is a perspective view of a portion of an elevator car of the multicar elevator system according to an embodiment of the invention;

FIG. 3 is a top view of the elevator car of FIG. 2 according to an embodiment of the invention;

FIG. 4 is a top view of a guide assembly of the elevator car according to an embodiment of the invention;

FIG. 5 is a perspective view of a guide assembly of the elevator car according to an embodiment of the invention;

FIG. 6 is a cross-sectional view of a guide assembly according to an embodiment of the invention; and

FIG. 7 is a perspective view of the guide assembly of FIG. 6 according to an embodiment of the invention.

The detailed description explains embodiments of the invention, together with advantages and features, by way of example with reference to the drawings.

### DETAILED DESCRIPTION OF THE INVENTION

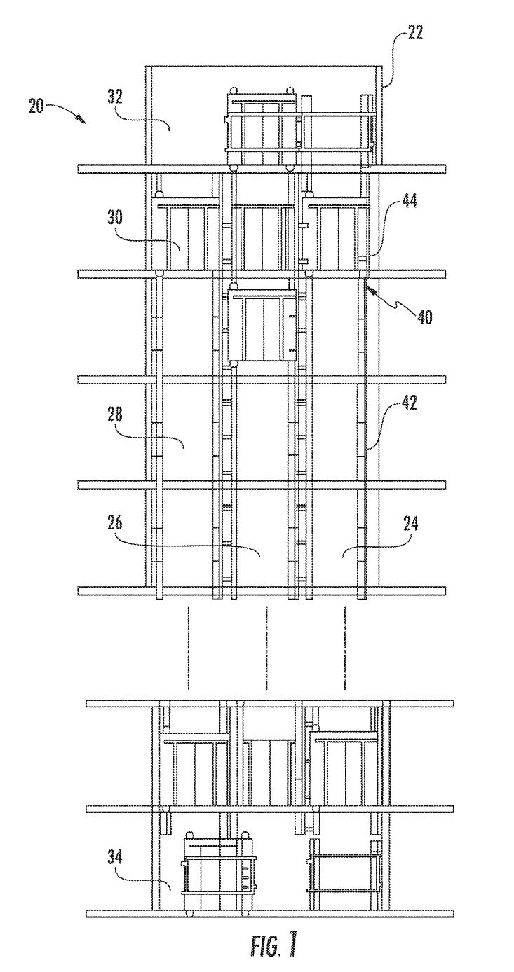

FIG. 1 depicts an example of a multicar, ropeless elevator system 20 that may be employed with embodiments of the invention. Elevator system 20 includes an elevator shaft 22 having a plurality of lanes 24, 26, and 28. While three lanes 24, 26, 28 are shown in FIG. 1, it is understood that various embodiments of the invention and various configurations of a multicar, ropeless elevator systems may include any number of lanes, either more or fewer than the three lanes shown in FIG. 1. One or more elevator cars 30 are configured to move vertically within each lane 24, 26, 28 in a single direction, i.e. up or down. In addition, an elevator car 30 is generally configured to move through one lane of the system 20 in a first direction and through another lane of the system 20 in a second, opposite direction. For example, as illustrated in the non-limiting embodiment of FIG. 1, an elevator car 30 in within lanes 24 and 26 is configured to travel vertically in an up direction and an elevator car 30 within lane 28 is configured to travel vertically in a down direction.

Located generally above the top floor of the building is an upper transfer station 32 configured to impart horizontal motion to the elevator cars 30 to move the elevator cars 30 between the plurality of lanes 24, 26, and 28. It is understood that upper transfer station 32 may be located at the top floor, rather than above the top floor. Similarly, below the first floor of the building is a lower transfer station 34 configured to impart horizontal motion to the elevator cars 30 to move the elevator cars 30 between the plurality of lanes 24, 26, and 28. It is understood that lower transfer station 34 may be located at the first floor, rather than below the first floor. Although not shown in FIG. 1, one or more intermediate transfer stations may be used between the first floor and the top floor. Intermediate transfer stations are similar to the upper transfer station 32 and lower transfer station 34, and are configured to impart horizontal motion to the elevator cars 30 at the respective transfer station. Further, although not shown in FIG. 1, the elevator cars 30 may stop at intermediate floors 40 to allow ingress to and egress from the elevator cars 30.

Cars 30 are propelled using a propulsion system 40 such as a linear, permanent magnet motor system having a primary, fixed portion 42 and a secondary, moving portion 44. One or more primary portion 42, such as including coils mounted on a structural member 46 for example, and may be positioned at one or both sides of the lanes 24, 26, and 28. The secondary portion 44 may include a plurality of permanent magnets 48 mounted to one or both sides of cars 30. Primary portion 42 is supplied with drive signals from one or more drive units (not shown) to control movement of the cars 30 in their respective lanes through the linear, permanent magnet motor system 40. The secondary portion 44 operatively connects with and electromagnetically operates with the primary portion 42 to be driven. The driven secondary portion 42 enables the car 30 to move along the primary portion 42 and thus move within a lane 24, 26, and 28.

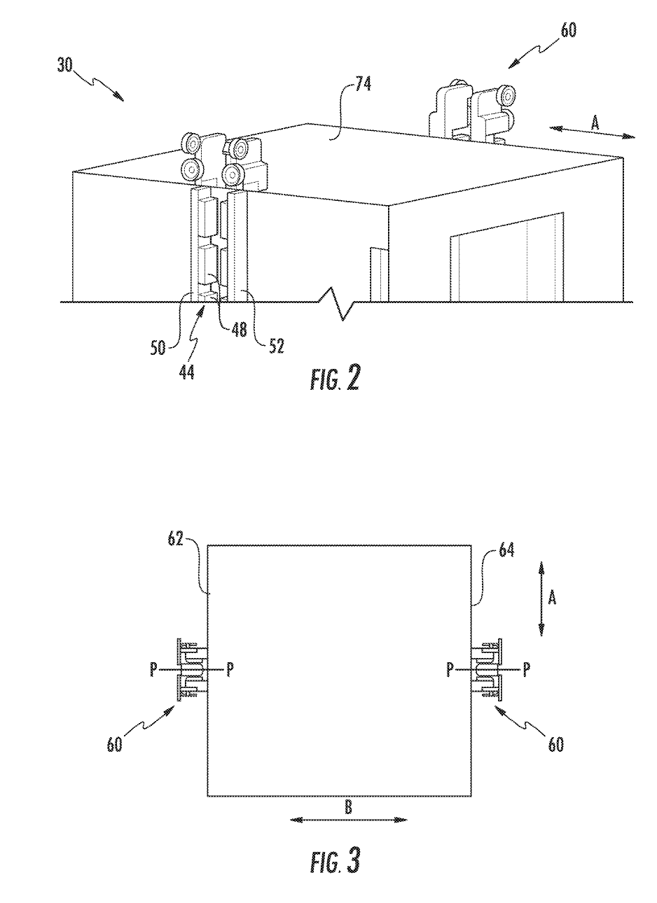

Referring now to FIG. 2, an elevator car 30 configured for use in the elevator system 20 is illustrated in more detail. The secondary portion 44 of the propulsion system 40 includes a plurality of permanent magnets 48 mounted to a first and second structural member 50, 52 extending from a side of the elevator car 30. The first and second structural member 50, 52 may be separate, or alternatively, may be integrally formed with one another. In one embodiment, the first structural member 50 and the second structural member 52 are connected to the elevator car 30 via a support member such that the elevator car 30 is isolated from noise and vibration generated as the elevator car 30 moves through a lane.

The elevator car 30 includes at least one guide assembly 60 configured to guide horizontal movement of the elevator car 30 as the car 30 moves vertically within a lane 24, 26, 28. In the illustrated, non-limiting embodiment, the elevator car 30 includes a first guide assembly 60 adjacent a first side 62 of the elevator car 30 and a second guide assembly 60 mounted adjacent a second, opposite side 64 of the elevator car 30. However, embodiments where the elevator car 30 includes only a single guide assembly 60 or where multiple guide assemblies 60 are arranged on a single side of the car 30 are within the scope of the invention.

In the illustrated, non-limiting embodiments, the guide assemblies 60 illustrated in FIGS. 2-7 includes a first guide support 66 and a second guide support 68 separated from one another by a distance to define a gap G there between. In the illustrated, non-limiting embodiment, the first and second guide supports 66, 68 both extend from a side of the elevator car 30 in the same direction, parallel to the first and second structural member 50, 52 of the secondary portion 44 of the propulsion system 40. As shown, the guide supports 66, 68 are generally rectangular in shape and have a substantially constant cross-section over their length. However, guide supports 66, 68 having other configurations are within the scope of the invention. The first guide support 66 and the second guide support 68 may be substantially symmetrical about a plane P (see FIG. 3) extending through the center of the gap G, parallel to the first and second guide support 66, 68. As shown, the gap G between the guide supports 66, 68 is greater than a width of the primary portion 42 of the propulsion system such that the first guide support 66 is generally positioned adjacent a first side of the primary portion 42 and the second guide support 68 is arranged near an opposite side of the primary portion 42. In one embodiment, the guide assembly 60 is connected to the elevator car 30 such that the gap G between the first and second guide support 66, 68 of the guide assembly 60 is substantially centered with the secondary portion 44 of the propulsion system 40.

A pair of first guides 70 is mounted to a portion of the first guide support 66 and the second guide support 68, respectively, such as at a distal end thereof, such that the first guides 70 are arranged within a plane substantially perpendicular to the guide supports 66, 68, and parallel to the adjacent surface of the elevator car 30. Together the first guides 70 are configured to guide “front to back” movement of the elevator car 30 to maintain the clearance between the primary and secondary portions 42, 44 of the propulsion system 40.

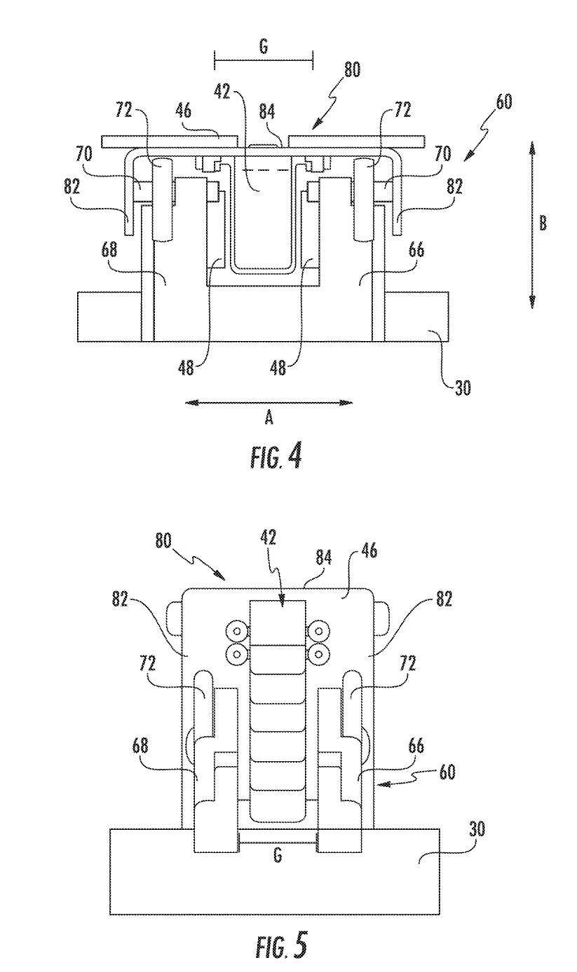

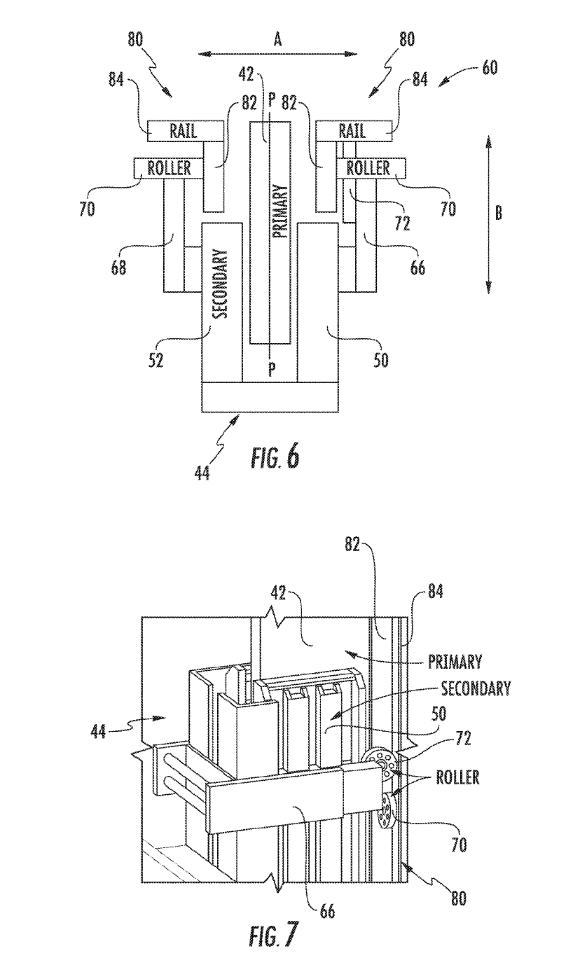

The guide assembly 60 additionally includes at least one second guide 72 mounted to either the first guide support 66 or the second guide support 68. Although the guide assembly 60 illustrated in FIG. 6 includes a single second guide 72, embodiments having additional second guides 72, such as two second guides 72 as shown in FIG. 4 for example, are within the scope of the invention. The second guide 72 is mounted vertically offset from an adjacent first guide 70 to prevent any interference there between. The second guide 72 is arranged within a plane substantially parallel to the guide supports 66, 68 of the guide assembly 60 and perpendicular to the pair of first guides 70 to guide “side to side” movement of the elevator car 30. In one embodiment, the structural members 50, 52 of the secondary portion 44 of the propulsion system 40 are configured as the first and second guide supports 66, 68 of the guide assembly 60 such that the first guides 70 and the at least second guide 72 are directly mounted thereto. Although the first and second guides are illustrated in the FIGS. as roller guides, other types of guides, such as a sliding guide for example, are within the scope of the invention. It will be understood that as used in this disclosure, the phrase “front to back” indicates the direction of arrow A and the phrase “side to side” indicates the direction of arrow B, as shown in FIG. 4.

In one embodiment, the at least one guide assembly 60 is coupled to or integrally formed with a portion of the elevator car 30. As shown in the embodiment of FIGS. 2-5, the guide assemblies 60 are mounted to the top or ceiling 74 of the elevator car 30. Alternatively, or in addition, one or more guide assemblies 60 may be arranged adjacent the bottom or floor (not shown) of the elevator car 30, or at any other location between the floor and ceiling 74 of the elevator car 30. Although the illustrated secondary portion 44 and guide assemblies 60 are centered about a first and second side 62, 64 of the car 30, embodiments where the secondary portion 44 and a guide assembly 60 aligned therewith is offset from the center are within the scope of the invention. In such embodiments, the guide assembly 60 on a first side 62 of the elevator car 30 and the guide assembly 60 on a second side 64 of the elevator car 30 may be offset in opposite, complementary directions.

In another embodiment, the at least one guide assembly 60 may be connected to the elevator car 30 indirectly through the secondary portion 44 of the propulsion system 40. For example, in the embodiment illustrated in FIGS., the first and second guide supports 66, 68 of the guide assembly 60 are coupled to or integrally formed with the first and second structural members 50, 52 of the secondary portion 44.

The guides 70, 72 of the guide assembly 60 are configured to contact and cooperate with one or more structural guide members 80 arranged adjacent the primary portion 42 of the propulsion system 40. The at least one structural guide member includes 80 a first wall 82 and a second wall 84 arranged substantially perpendicular to one another. For example, in the embodiment illustrated in FIG. 6, a first structural guide member and a second symmetrical guide member, such as angles each having a perpendicular first and second wall, are arranged symmetrically on opposing sides of the primary portion 42 of the propulsion system 40. In another embodiment, a single structural guide member 80, such as a C-channel or U-channel for example, includes a plurality of first walls 82 extending perpendicularly from opposing ends of a second wall 84. In such embodiments, the single structural guide member 80 may be integrally formed with the structural member 46 configured to support the primary portion 42.

Each first guide 70 of the guide assembly 60 is configured to contact a first wall 82 of the at least one structural guide member 80 and the at least one second guide 72 is configured to contact a second wall 84 of the at least one structural guide member 80. The first guides 70 and the at least one second guide 72 may be spring biased into contact with the one or more structural guide members 80. In other embodiments, the guide assembly 60 may be an active guide assembly including a plurality of actuators connected to the first guides 70 and the second guides 72 to not only improve the positioning of the secondary portion 44 relative to the primary portion 42 of the propulsion system 40, but also to dampen vibration of the elevator car 30 as it moves within a lane 24, 26, 28.

Other components of the elevator system 20 may be configured to interact with the at least one structural guide member 80. For example, a brake (not shown) mounted to the elevator car 30 may engage a portion of at least one structural guide member 80 to slow or stop movement of an elevator car 30. Similarly, one or more safety devices (not shown) may be mounted to the guide assembly 60 or the elevator car 30. In one embodiment, the safety devices are also configured to engage a portion of the at least one structural guide member 80 to stop vertical movement of the elevator car 30, such as in the event of an emergency for example.

An elevator car having one or more guide assemblies 60 as described herein allow vertical movement of an elevator car 30 while retaining critical alignments between the primary and secondary portions 42, 44 of the propulsion system 40, as well as other stopping devices. By simplifying the complexity and limiting the size of the guide assembly 60, both a space and cost savings are achieved. In addition, by isolating the guide assembly 30 from the elevator car 30, the ride quality within the elevator car 30 is improved.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments and/or features.

What is claimed is:

1. A guide assembly for guiding movement of an elevator car, the guide assembly comprising:
a first guide support and a second guide support coupled to a portion of an elevator car and separated from one another by a gap, wherein the gap is wider than an adjacent primary portion of a propulsion system of the elevator system;
a pair of first guides mounted to the first guide support and the second guide support respectively, the pair of first guides being substantially parallel and configured to guide movement of the elevator car in a first direction such that a clearance is maintained between the primary portion and a secondary portion of a propulsion system mounted to the elevator car;
at least one second guide mounted to one of the first guide support and the second guide support, the at least one second guide being oriented substantially perpendicular to the first guides, the second guide being configured to guide movement of the elevator car in a second direction.

2. The guide assembly according to claim 1, wherein the first guide support and the second guide support are symmetrical about a plane extending parallel to the first and second guide support through a center of the gap.

3. The guide assembly according to claim 1, wherein the first guide support and the second guide support are connected directly to a portion of the elevator car.

4. The guide assembly according to claim 1, wherein the first guide support and the second guide support are integrally formed with a portion of the elevator car.

5. The guide assembly according to claim 1, wherein the first guide support and the second guide support are indirectly coupled to the elevator car via a support member such that the elevator car is isolated from noise and vibration.

6. The guide assembly according to claim 1, wherein the first guide support is a first structural member of the secondary portion of the propulsion system and the second guide support is a second structural member of the secondary portion of the propulsion system.

7. The guide assembly according to claim 1, wherein the first guide support is connected to a first structural member of the secondary portion of the propulsion system and the second guide support is connected to the second structural member of the secondary portion of the propulsion system.

8. The guide assembly according to claim 7, wherein the first guide support and the second guide support extend substantially parallel to the first structural member and the second structural member.

9. The guide assembly according to claim 1, further comprising at least one actuator such that one or more of the first guides and the at least one second guide is active.

10. An elevator system, the guide system comprising:
at least one elevator car;
at least one vertical structural guide member arranged adjacent a primary portion of a propulsion system of the elevator car;
a secondary portion of the propulsion system being coupled to the elevator car, the secondary portion being arranged generally parallel to the primary portion of the propulsion system; and
at least one guide assembly configured to limit horizontal movement of the elevator car, the guide assembly including:
a first guide support and a parallel second guide support coupled to a portion of the elevator car and separated from one another by a gap, wherein the gap is wider than the primary portion of a propulsion system;
a pair of first guides mounted to the first guide support and the second guide support respectively, the pair of first guides being configured to contact one or more first wall of the at least one structural guide member to limit movement of the elevator car in a first direction such that a clearance between the primary portion and the secondary portion of the propulsion system is maintained; and
at least one second guide mounted to one of the first guide support and the second guide support, the at least one second guide being oriented substantially perpendicular to the first guides, the second guide being configured to contact a second wall of the at least one structural guide member to guide movement of the elevator car in a second direction.

11. The elevator system according to claim 10, wherein the first guide support and the second guide support are directly connected to a portion of the elevator car.

12. The elevator system according to claim 10, wherein the first guide support and the second guide support are integrally formed with a portion of the elevator car.

13. The elevator system according to claim 10, wherein the first guide support and the second guide support are indirectly coupled to the elevator car via a support member configured to isolate the elevator car from noise and vibration of the at least one guide assembly.

14. The elevator system according to claim 13, further comprising at least one of a safety device and a brake mounted to the elevator car, wherein at least one of the safety device and the brake are configured to engage the support member to slow or stop movement of the elevator car.

15. The elevator system according to claim 10, wherein the first guide support is a first structural member of the secondary portion of the propulsion system and the second guide support is a second structural member of the secondary portion of the propulsion system.

16. The elevator system according to claim 10, wherein the first guide support is connected to a first structural member of the secondary portion of the propulsion system and the second guide support is connected to a second structural member of the secondary portion of the propulsion system.

17. The elevator system according to claim 16, wherein the first guide support and the second guide support extend substantially parallel to the first structural member and the second structural member.

18. The elevator system according to claim 10, further comprising at least one actuator such that one or more of the first guides and the at least one second guide is active.

19. The elevator system according to claim 10, wherein the at least one structural guide member includes a plurality of first walls extending from opposing ends of the second wall, the plurality of first walls and second walls being integrally formed.

20. The elevator system according to claim 19, wherein the at least one structural guide member is a C-channel.

21. The elevator system according to claim 10, wherein the at least one structural guide member includes a first structural guide member and a second structural guide member arranged symmetrically on opposing sides of the primary portion of the propulsion system.

22. The guide system according to claim 21, wherein the first structural guide member and the second structural guide member are angles.
